(19) United States
(12) Patent Application Publication
(10) Pub. No.: US 2026/0193117 A1
(43) Pub. Date: Jul. 9, 2026

(54) CONTAINERIZED WATER TREATMENT PLANT

(71) Applicant: WORLD WIDE CLEAN WATER, LLC, HOBE SOUND, FL (US)

(72) Inventors: Dennis E. McGuire, Stuart, FL (US); William O. Brisben, Jupiter Island, FL (US)

(21) Appl. No.: 19/409,041

(22) Filed: Dec. 4, 2025

Related U.S. Application Data
(60) Provisional application No. 63/743,433, filed on Jan. 9, 2025.

(51) Int. Cl. C02F 1/78; C02F 1/00; C02F 1/32; C02F 1/44

(52) U.S. Cl. CPC C02F 1/78; C02F 1/004; C02F 1/32; C02F 1/441; C02F 2201/002; C02F 2201/008; C02F 2201/009; C02F 2209/005; C02F 2209/10; C02F 2303/04

(57) ABSTRACT

A mobile, containerized water treatment system is provided, comprising three modular 20-foot high-cube containers that operate independently or in combination to produce potable water from a wide range of raw water sources. A first container houses a 500 GPM treatment train including a suction pump, chopper pump, ozone injection subsystem, and a hydrodynamic cavitation unit for maceration, oxidation, and disinfection without the use of added chemicals. A second container houses a 500 GPM multimedia filtration system employing zeolite and one-micron filter elements to remove suspended solids and residual contaminants. A third container houses a reverse osmosis system sized to treat approximately 325 to 500 GPM and capable of reducing total dissolved solids to potable levels. The modular configuration allows the containers to be mixed, matched, or deployed in parallel to meet specific influent quality and effluent purity requirements while minimizing environmental impact and eliminating secondary pollution.

### PRIORITY CLAIM

In accordance with 37 C.F.R. 1.76, a claim of priority is included in an Application Data Sheet filed concurrently herewith. Accordingly, the present invention claims the priority date of 01/09/2025 of U.S. Provisional Patent Application Serial No. 63/743,433 entitled CONTAINERIZED WATER TREATMENT PLANT, the contents of which is incorporated herein by reference.

### FIELD OF THE INVENTION

This invention is directed to the field of water treatment and, in particular, to containerized mobile water treatment plants configurable for treating industrial and potable waters.

### BACKGROUND OF THE INVENTION

Clean water is essential for health, ecosystems, and economic development. Clean water is crucial for reducing the spread of waterborne diseases, contaminated water is a leading cause of illness and death, especially in developing regions. Access to clean water is necessary for proper hygiene practices and is essential for hydration and overall bodily function. Clean water reduces the burden of disease, allowing individuals to work and attend school, thereby improving quality of life and economic productivity.

Clean water is essential for irrigation, ensuring safe and sufficient food production. Industries rely on clean water for manufacturing, processing, and cooling. Investing in clean water infrastructure and protecting water sources from pollution are critical for sustainable development and global well-being.

Water quality can change quickly due to a variety of natural and human-induced factors. These changes can occur in response to sudden events or gradual processes that disrupt the balance of a water source. Surface water changes can be the result of rainfall which can wash soil, debris, and pollutants into water bodies, increasing turbidity and contaminant levels. Higher temperatures can increase algae blooms and bacterial growth, while colder temperatures can reduce biological activity. Fertilizers and pesticides can wash into water bodies, increasing nutrient levels and causing eutrophication. Factories can release chemicals and heavy metals, causing rapid contamination. Untreated or poorly treated wastewater can introduce pathogens and nutrients into water sources.

Efforts to monitor water quality and manage contributing factors are essential to mitigate these rapid changes and protect water resources. What is needed in the art are water treatment systems that can be mixed and matched to treat various and changing water supplies.

### SUMMARY OF THE INVENTION

Disclosed is a mobile water treatment system that can be mixed and matched for treating a wide range of industrial and potable waters. The system is based on High Cube shipping containers that are universally transportable. The water treatment plant is capable of converting brackish water (city water, river water, lake water etc. water sources) with TDS≈3,000 mg/L into fresh water with TDS≤ 100 mg/L, which can be applied for human consumption. The mobile water treatment plant employs three 20’ high cube shipping containers having with roll up doors for a 500 GPM cavitation system (#1 container), a 500 GPM filtration system (#2 container) and a 325 GPM reverse osmosis system (#3 container). This system treats 30,000 GPH for bacteria kill when just the #1 and #2 containers are used. There is no filtration after the #1 container but when the #2 container is used the water is filtered to an absolute 5 micron. Employing the #3 container, with #1 and #2 for make-up water, provides for high quality drinking water using a reverse osmosis system capable of converting brackish water (city water, river water, lake water etc. water sources) with TDS≈3,000 mg/L into fresh water with TDS≤ 100 mg/L, which can be applied for human consumption.

Container #1 consists of trash pump, bag filter, chopper pump, ozone injection, and hydrodynamic cavitation system; container #2 consists of a zeolite filter and security filter; and container #3 consists of a reverse osmosis system having a high pressure pump, RO membranes within pressurized vessels.

An objective of the instant invention is to provide containerized water treatment systems that can be mixed and matched to accommodate various water quality requirements.

Still another objective of the invention is to provide conventional sized containers for ease of shipping having roll-up side doors allowing service of equipment without entering the container.

Another objective of the invention is to provide a water treatment system that does not require chemical feed for bacterial treatment, particulate matter, or BWRO make-up water.

Still another objective of the invention is to provide a containerized water treatment system that will meet EPA guidelines for discharge using Container #1 and #2, or meet EPA guidelines on allowable PFAS in drinking water using Containers #1, #2 and #3.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a flow diagram of the cavitation system within Container #1;

FIG. 2 is a cross sectional view of a cavitation mixer;

FIG. 3 is a flow diagram of the treatment system within Container #2; and

FIG. 4 is a flow diagram of the reverse osmosis system within Container #3.

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

A mobile water treatment plant for treating a wide range of industrial and potable waters. The system is based on three 20 foot long High Cube shipping containers. The water treatment plant is capable of converting brackish water (city water, river water, lake water etc. water sources) with TDS≈3,000 mg/L into fresh water with TDS≤ 100 mg/L, which can be applied for human consumption. A pretreatment system consists of trash pump, bag filter, chopper pump, ozone injection, hydrodynamic cavitation system, zeolite filter and security filter. The RO systems include high pressure pump, RO membranes as well as pressurized vessels. RO membranes configured to reduce TDS, organic compounds, and emerging contaminants such as PFAS and PFOS.

The system further incorporates a programmable logic controller (PLC) control system, interlocks, instrumentation, and a clean-in-place (CIP) subsystem designed to recover membrane flux and restore RO performance when fouled or scaled. The CIP module enables periodic maintenance using heated or unheated CIP solutions to flush the RO membranes and return permeate production rates to expected levels.

This set of containerized water treatment equipment includes three 20 HQ containers with roll up doors. Container #1: a 500 GPM cavitation and ozone-based pretreatment system; Container #2: a 500 GPM multimedia filtration system utilizing zeolite and micron-level filtration; Container #3: a 325 GPM reverse-osmosis system. The containerized construction facilitates deployment in remote locations, disaster-relief scenarios, mining and industrial sites, military or humanitarian operations, and municipal augmentation. The containers are designed for forklift and crane handling, allowing the units to be transported via truck, rail, or sea freight. The roll-up doors maximize interior access, enabling operators to service equipment externally without fully entering the container, simplifying maintenance and reducing downtime. Because the system relies primarily on physical treatment mechanisms—including cavitation, ozone oxidation, mechanical shearing, and reverse osmosis—no chemical disinfectants, flocculants, or coagulants are required. The system thereby eliminates the risk of secondary chemical pollution and reduces daily operating costs associated with chemical dosing and storage.

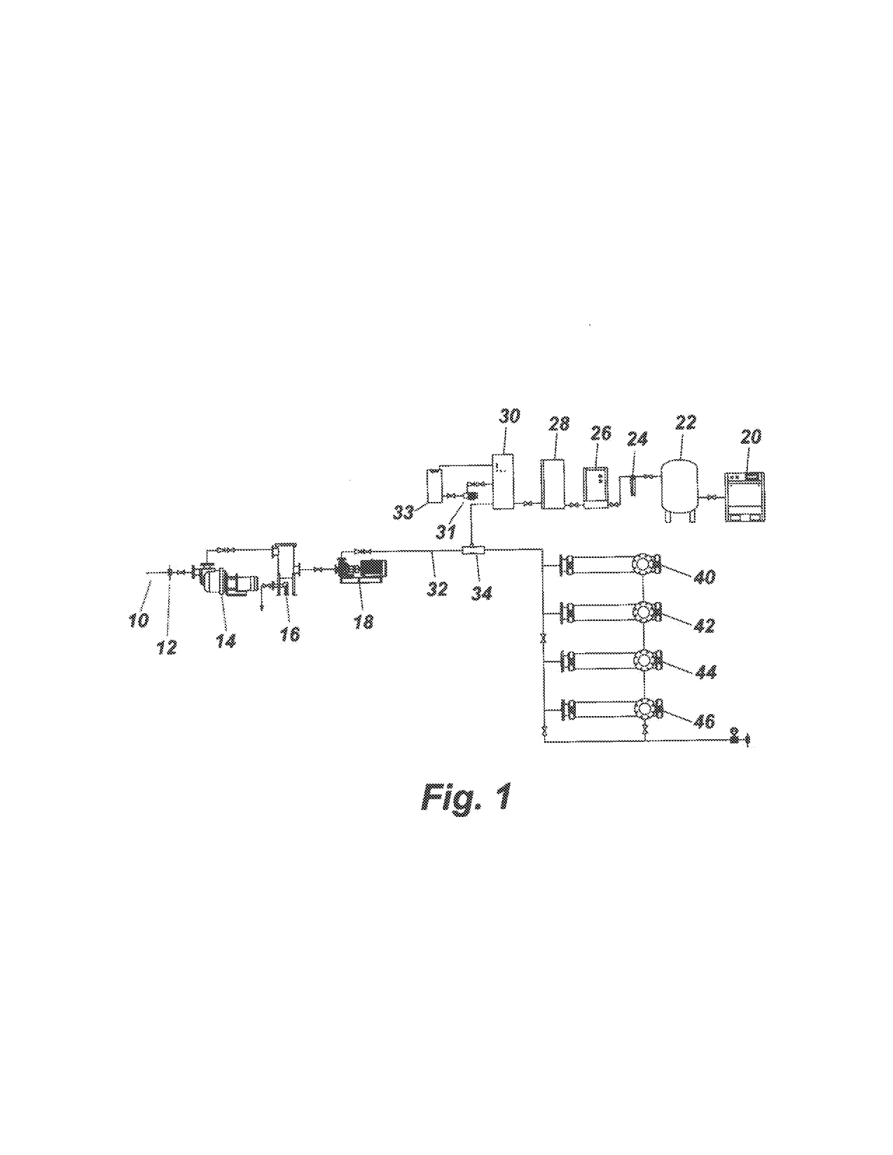

Referring to FIG. 1, pre-treatment using hydrodynamic cavitation, high-intensity ozone injection, and Zeolite filtration to effectively remove all impurities larger than 5 microns in the water and ozone injection system can greatly remove chemical molecules and effectively remove suspended matter, mud and sand, particles, organosilicon colloid, organic matter, residual chlorine and other impurities in raw water, remove dissolved salts, bacteria, heat sources, etc. This design has been proven to be far more effective than the traditional method of injecting chemicals such as bactericide and reductants into the water, with no chemical contamination of the water and much lower daily operating costs than chemicals injection. While the raw water is initially treated, the subsequent RO system can be well protected to minimize the maintenance cost. The high precision RO system can remove more than 99% of the chemical molecules and other harmful substances in the water. This integrated pretreatment approach has demonstrated superior performance compared to conventional chemical pretreatment methods, which typically rely on bactericides, reductants, and coagulants. By eliminating chemical reagents, the system achieves a more environmentally benign operation and reduces the long-term operational expenditure. Moreover, the enhanced pretreatment protects downstream RO membranes from fouling, scaling, and biofouling, thereby reducing membrane replacement frequency and extending the life of the RO system.

Container #1 comprises a first system comprising an inlet 10 that passes through the boundary wall 12 of the container. The inlet 10 feeding a high head suction pump 14 to draw water from a lake, river bank, or other water source. The pump 14 integrates self-priming and non-clogging sewage discharge, adopts external mixed structure, and combines self-priming and non-clogging function through a pump body and impeller channel capable of conveying liquids containing suspended particles and fibrous particles. A 100 micron stainless steel basket filter 16 is used to remove any material drawn through the suction pump 14. In a preferred embodiment, a rocker arm bag filter is employed. The rocker arm lifts a top cover for ease of accessing three stainless steel bag filters allow 500 GPM filtering.

A chopper pump 18 functions like a rotating hydrodynamic cavitation device to start violently chopping the water and creating hydrodynamic cavitation but also reducing the various magnetic attractions of the PFAS chemicals to each other or other contaminants and reducing the laminar flow and surface tension of having a laminar type flow to be very violent. The chopper pump 18 is a centrifugal pump using double-chopper design for conveying viscous fluids and sewage and wastewater containing solid particles, with a cutting device inside the pump casing to effectively cut through solid impurities and molecules in the water. The cutting device is a steel knife impeller effective in destroying and shredding debris when pumping water. The chopper pump is preferably a variable frequency drive (VFD) pump which adjusts the flow rates of the water through the system for longer or shorter dwell time for the ozone and cavitation. A range of about 300 grams per hr of ozone can be applied and the amount can be raised or lowered from that range. This instant container allows 500 GPM (30,000 GPH) and can be used as a standalone product on a trailer or in a building to kill bacteria in frack water, or in ponds with chicken poop, dairy poop, pig poop, algae, pulp and paper bacteria from bugs used in bioreactors, etc. The container is constructed and designed to raise the ORP in any body of water that bacteria has lowered the oxidation–reduction potential (ORP). The ozone destroys bacteria. The chopper pump action and the hydrodynamic mixer blades explode the bacteria cell walls, the bubble collapses, causing heat temps and micro explosive actions. The processes increase ORP, destroy bacteria via shear-induced cell rupture, and create micro-explosive cavitation events capable of disrupting PFAS molecular structures.

Ozone is generated on-site beginning with an air compressor 20 feeding an air storage tank 22. The compressed air passes through a one-micron particulate filter 24, followed by a refrigerated air dryer 26 to remove entrained moisture. The dried air then enters an oxygen generator 28, which employs pressure swing adsorption (PSA) to separate nitrogen and concentrate oxygen to a purity of approximately 95%.

The dry air is directed into an oxygen generator 28 and introduced into an ozone generator 30. The ozone generator 30 includes a pump 31 that recirculates cooling fluid through holding tank 33. The ozone generator 30 adopts high temperature resistant HQG non-glass structure discharge unit which is extremely stable, has a high discharge efficiency, and is not readily damaged by backwater. Moisture-resistant high-voltage package inside the machine adopts epoxy resin potting design which can work normally even in humid environment. Ozone is used to destroy the structure of microbial membranes by the oxidation of oxygen atoms to achieve bactericidal action. Unlike other bactericidal agents, ozone reacts with the double bonds of lipids in the bacterial cell wall, penetrating into the bacterium and acting on proteins and lipopolysaccharides to change the permeability of the cell, leading to bacterial death. Ozone also acts on the nuclear material in the cell, such as purines and pyrimidines in nucleic acids to destroy DNA. Ozone first acts on the cell membrane, causing damage to the membrane components and leading to metabolic disorders. Ozone continues to penetrate through the membrane and destroys lipoproteins and lipopolysaccharides in the membrane, changing the permeability of the cell and leading to cell lysis and death. Since ozone is difficult to dissolve in water, in order to make ozone achieve the ideal sterilization effect, the use of micro-nano bubble generator, so that the ozone and water in a certain pressure time is fully mixed. The device adopts the oxygen molecules as the adsorbent to separate oxygen and nitrogen by Pressure Swing Adsorption (PSA) and filters out the harmful substances so as to obtain the high concentration of oxygen in accordance with the medical standard. PSA oxygen generating equipment provides the oxygen with the purity of 95%. The refrigerated dryer 26 utilizes refrigerant and compressed air for heat exchange to reduce the dew point of an air source and control it between 2-10 degrees Celsius. The ozone enters a flow stream 32 from the chopper pump 18 through injector 34. Cavitation mixers 40, 42, 44, and 46 are pl hydrodynamic cavitation + ozone injection as a feeding water and preliminary treatment system not only to displace chemical injection but also the water source is widened to be able to treat feed water with large particles such as leaves, grass and so forth. This allows the system to be moved to some emergency sites for quickly making fresh water for human consumption. Mixing of ozone is performed by use of four 8” wide by 36” long hydrodynamic cavitation mixers 40, 42, 44, and 46. These mixers create micro and nano-bubbles under pressure, dramatically improving ozone transfer efficiency and producing powerful oxidative effects without chemical additives.

The mixing process of the static mixer is a series of different specifications of the mixing units installed in the hollow pipe to mix the fluid for decomposition and crushing the molecules in the water, the process will produce a large number of hydroxide ions during the high-speed mixing to cut and decompose harmful substances in the fluid. Fluid passes though the mixers sometimes left rotation, sometimes right rotation, constantly changing the direction of flow mixing, not only the center of the fluid pushed to the periphery, but also the periphery of the fluid pushed to the center, resulting in a good radial mixing effect. At the same time, the rotating effect of the fluid itself will also occur at the interface of the adjacent components, this high-speed radial circulation mixing will make the fluid fully mixed, through the mixing unit fixed in the pipe or multiple streams of fluid cutting, shearing, rotating and remixing, to achieve the purpose of a good dispersion between the fluids and fully mixed.

The array of static mixing elements impart alternating left-hand and right-hand rotational flows, continuously shifting the water from center to periphery and back. These mixers generate high-velocity shear, turbulence, and pressure differentials that cause cavitation and molecular fragmentation within the water stream. As water flows through sequential mixing units, the turbulence produces hydroxyl radicals and intense fluid shear, causing the disintegration of harmful compounds. The combination of cutting, shearing, rotating, and remixing actions produces complete radial and axial dispersion, ensuring uniform cavitation and ozone exposure throughout the flow.

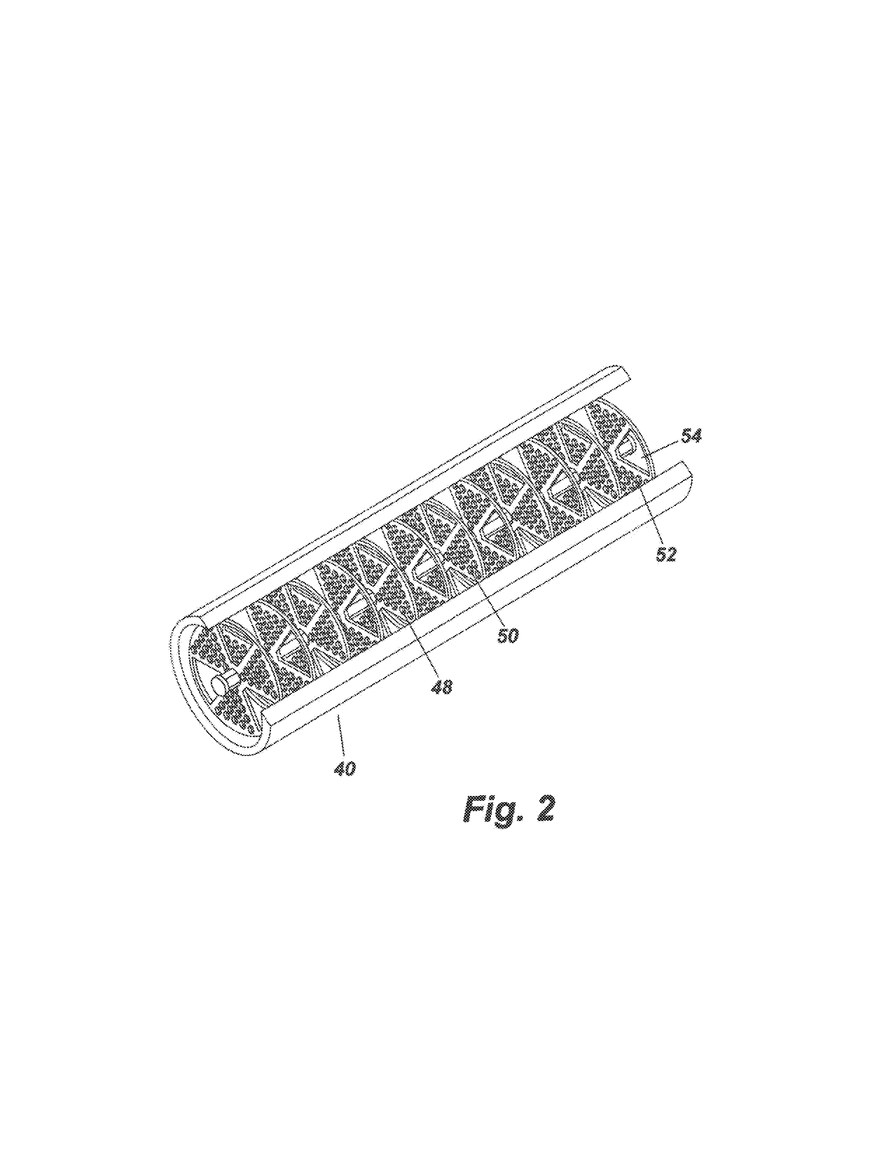

Referring to FIG. 2, the 8” hydrodynamic cavitation mixers are tubular in diameter with a series of plates 48 having hexagon symmetry of 60 degrees. The shape optimally balances area and perimeter, making hexagonal grids a most material-efficient way to divide a plane with each internal angle in a regular hexagon to be 120°, which contributes to its tessellation properties and gives the shape its distinct, balanced appearance. The plate 48 having three grids 50 with hexagon openings 52, and three pass through grids 54. Each plate 48 having an alternate position wherein water flows through a torturous path alternating between an open grid and a grid having a plurality of hexagon shaped openings. The flow of water through the mixers causing Sonoluminescence wherein a strong acoustic wave is formed in the liquid which creates a small gas bubble. Pressure changes from the sound wave cause the bubbles to expand and contract rapidly, wherein the bubble undergoes a process of extreme compression to create a momentary, tiny “hot spot” within the bubble used in exploding the cells of any bacteria.

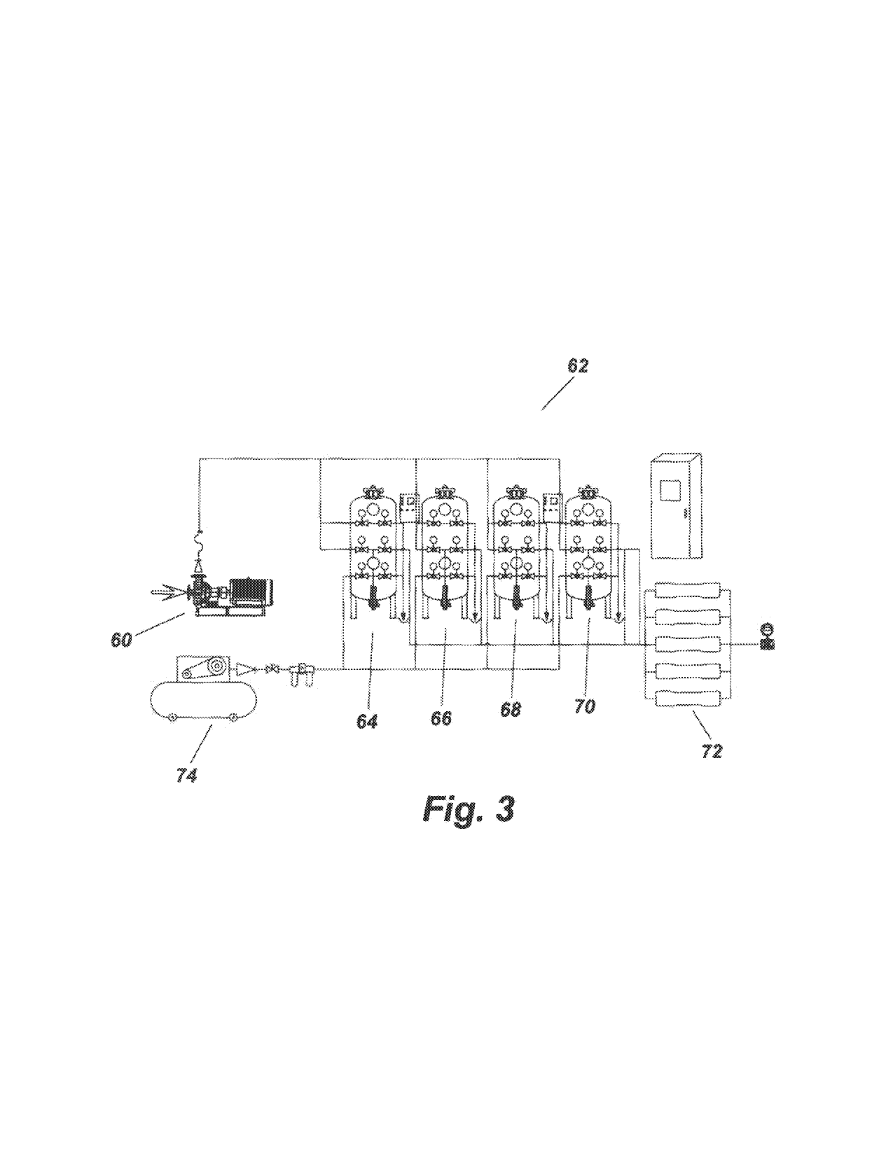

Referring to FIG. 3, Container #2 comprises a 500 GPM feed pump 60 and multi-media system 62 that uses media in multiple sizes to obtain one micron filtration. Four tanks 64, 66, 68 and 70, each having a flow rate of 125 GPM are parallel plumbed to net 500 GPM. The media can be operated at twice the flow rate of sand, anthracite or activated carbon. The preferred media is sold under the trade name Zeomedia using two grades of Zeolite,12-20 and 14-40. Zeolite can adsorb impurities and heavy metal ions in water, such as lead, mercury, cadmium, chromium, etc., to remove divalent ions in the water and reduce the hardness of the water so as to improve the quality of water. Zeolite has strong ion exchange property, it can exchange ions with ionized ions or macromolecules to change the ion concentration of water and improve the quality of water. In water treatment zeolite is used to reduce pH value and remove fluoride ions, iron ions, organic substances that are difficult to decompose and stabilize in water. The multi-media can filer to 1 micron. Following the media filter, 5 micron filters 72 are used as a final treatment in this container before water is introduced to a third container houses an RO system. Containers 1 and 2 provide ideal protection of RO membranes wherein the Zeolite reduces operating costs considerably over conventional RO treatment, providing cleaner water to the RO container verses using conventional sand and carbon multimedia. An air compressor 74 facilitates the back washing of the media filter to assure maximum cleaning.

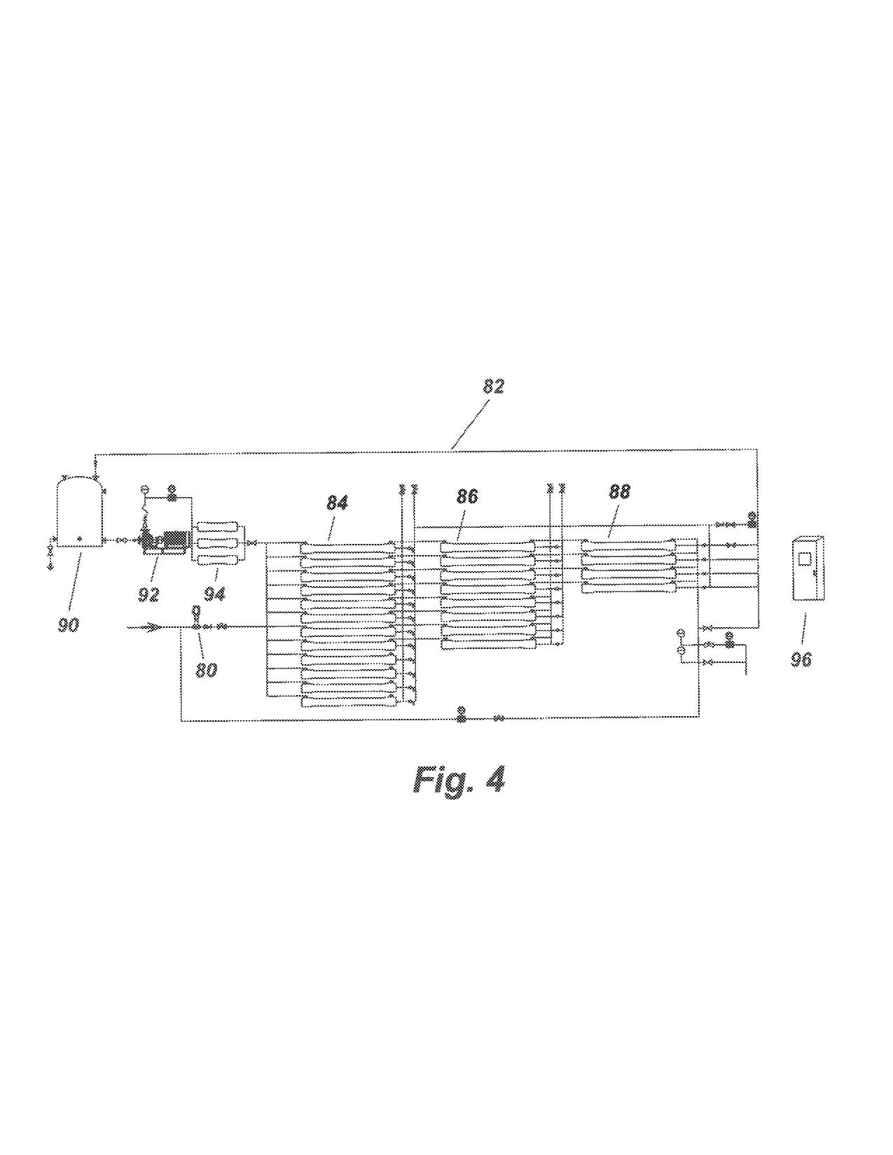

Referring to FIG. 4, Container #3 contains a high pressure pump 80 and a Reverse Osmosis system 82. The RO system preferably employs Toray cross-linked aromatic polyamide composite membranes. The RO system can remove more than 99% of the chemical molecules and other harmful substances in the water using the BW-RO membrane, which has a high desalination rate, a single membrane desalination rate of 99.5%, the system desalination rate of 98%, and can effectively remove particles, organosilicon colloids, bacteria, heat sources, hardness, PFAS/PFOS, chemicals and other impurities in the raw water.

The reverse osmosis system membranes remove colloidal particles, bacteria from the feed water, and lower the total dissolved solids for producing potable water. The membranes separate water and salt solution; water would permeate from the salt solution side under the osmotic pressure. If certain pressure larger than osmotic pressure is applied on the salt solution, water would permeate for the opposite direction. This phenomenon is called reverse osmosis. RO permeate is purified, removing more than 98% TDS from the feed water. Pretreated water is lifted by a high pressure pump to 1-1.6MPa. High pressure feed water is treated by RO device, producing purified permeate water and exhausting brine water. In operation, pressurized water passes through the reverse osmosis pore size of 0.0001 micron permeable membrane. Chemical ions and bacteria, fungi and viruses cannot be passed through and discharged with the concentrated water, wherein the membranes only allow the volume of water and solvents molecules less than 0.0001 microns get through, it can effectively remove dissolved salts in water, colloids, bacteria, viruses, bacterial endotoxins and inorganic salts (calcium, magnesium), heavy metal ions, organic matter, colloids and other impurities. The main separation object of the reverse osmosis membrane is the range of ions in solution, which can effectively remove the salts in the water without chemicals and the desalination rate of the system is generally above 98%. The recovery rate and working pressure can be adjusted by regulating the brine flow valve.

This reverse osmosis system produces 325 GPM of very high grade water free of PFAS/PFOS chemicals from a 500 GPM feed wherein the system treats 30,000 GPH for bacteria kill when container #1 and #2 container is used. There is no filtration after #1 container but when #2 is used the water is filtered to an absolute 1 micron. The system is constructed and arranged to work individually or in combination, wherein most raw water influents can be treated into usable water including potable water.

The system is equipped with backwashing system 90 having a recirculation storage tank 90 which feeds a cleaning pump 92 followed by 5 micron filtration 94. A PLC microcomputer control system 96 provides for convenient operation and small manual maintenance by use of a fully automatic control system. This greatly reduces the need for specialized operators and thus reduces the labor costs associated with the operation of the plant. For the current public concern of PFOS / PFAS, chlorine and residual chlorine, and other extremely harmful impurities to the human body and the prevalence of chemical substances in the drinking water can have a very good treatment results, for chlorine and residual chlorine treatment can reach 99.5%, and for the PFAS / PFOS can reach 98% of the treatment effect. The preferred embodiment has a first bank of 12 filters 84, a second bank of 8 filters 86 and a third bank of 4 filters 88.

The use of the word "a" or "an" when used in conjunction with the term "comprising" in the claims and/or the specification may mean "one," but it is also consistent with the meaning of "one or more" or "at least one." The use of the term "or" in the claims is used to mean "and/or" unless explicitly indicated to refer to alternatives only or the alternative are mutually exclusive, although the disclosure supports a definition that refers to only alternatives and "and/or."

The terms "comprise" (and any form of comprise, such as "comprises" and "comprising"), "have" (and any form of have, such as "has" and "having"), "include" (and any form of include, such as "includes" and "including") and "contain" (and any form of contain, such as "contains" and "containing") are open-ended linking verbs. As a result, a method or device that "comprises," "has," "includes" or "contains" one or more steps or elements, possesses those one or more steps or elements, but is not limited to possessing only those one or more elements.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. . A mobile water treatment system, comprising:
a first modular 20-foot long shipping container housing a 500gpm suction pump configured to draw raw water; a chopper pump constructed and arranged for maceration of solids in the raw water; an ozone injection subsystem configured to inject ozone into the macerated water; and a hydrodynamic cavitation system configured to subject the ozonated water to cavitation for disinfection and oxidation;
a second modular 20-foot long shipping container housing a 500 gpm pump constructed and arranged to direct water through a plurality of multimedia filters comprising zeolite media and one-micron filters;
a third modular 20-foot long shipping container housing a 500 gpm pump constructed and arranged to direct water through a reverse osmosis (RO) system capable of reducing total dissolved solids (TDS) in the water;
wherein said first, second and third modular containers can operate independently or in combination to provide potable water from most any source.

2. The mobile water treatment system according to claim 1 wherein cavitation mixers are constructed and arranged to induce sonoluminescence by generating an acoustic wave within the water.

3. The mobile water treatment system according to claim 1 wherein said first and second containers are operated in combination for processing up to 30,000 gallons per hour (GPH) for bacterial elimination and filtration.

4. The mobile water treatment system according to claim 1 wherein said first, second and third containers are operated in combination to facilitate the production of water suitable for human consumption.

5. The mobile water treatment system according to claim 4 wherein potable water is produced when the TDS of incoming water is 3,000 mg/L or less.

6. The mobile water treatment system according to claim 1 wherein said hydrodynamic cavitation mixers are tubular in diameter with a series of plates having hexagon grid symmetry of about 60 degrees.

7. The mobile water treatment system according to claim 6 wherein said plate having three grids with hexagon openings and three pass through grids, wherein a following plate is placed at an alternate position wherein water flows through a torturous path alternating between an open grid and a grid having a plurality of hexagon shaped openings.

8. The mobile water treatment system according to claim 1 wherein each said container includes a rollup side door for ease of access to equipment mounted in the container.

9. The mobile water treatment system of claim 1, wherein each of the first, second, and third containers includes a roll-up side door providing access to equipment mounted within the container.

10. The mobile water treatment system of claim 1, further comprising an ultraviolet (UV) disinfection unit positioned downstream of the hydrodynamic cavitation system.

11. The mobile water treatment system of claim 1, wherein the multimedia filters further comprise activated carbon media.

12. The mobile water treatment system of claim 1, further comprising a programmable logic controller (PLC) configured to autonomously manage pump operation, flow balancing, and safety shutdowns, said PLC configured to monitor turbidity, oxidation-reduction potential (ORP), and total dissolved solids (TDS) in real time.

13. The mobile water treatment system of claim 1, further comprising a bypass manifold enabling selective diversion of water around the hydrodynamic cavitation system, the multimedia filters, or the RO system.

14. The mobile water treatment system of claim 1, further comprising an onboard diesel generator configured to power the pumps and treatment subsystems.

15. The mobile water treatment system of claim 1, further comprising ISO-standard forklift pockets and corner castings to facilitate transport and deployment, and includes vibration-damped equipment mounts adapted to maintain system alignment during transport.
